(19) United States
(12) Patent Application Publication
(10) Pub. No.: US 2003/0194352 A1
(43) Pub. Date: Oct. 16, 2003

(54) Device for closing a plurality of digestion vessesls

(75) Inventor: Werner Lautenschlager, Leutkirch (DE)

Correspondence Address: FITZPATRICK CELLA HARPER & SCINTO, 30 ROCKEFELLER PLAZA, NEW YORK, NY, 10112, US

(73) Assignee: MILESTONE S.R.L., SORISOLE (BG) (IT)

(21) Appl. No.: 10/368,582

(22) Filed: Feb. 20, 2003

Related U.S. Application Data
(63) Continuation-in-part of application No. 10/316,951, filed on Dec. 12, 2002.
(63) Continuation-in-part of application No. 10/099,443, filed on Mar. 15, 2002.

(30) Foreign Application Priority Data
Dec. 20, 2002 (EP) EP 02 028 588.8
May 3, 2002 (DE) 202 07 013.1
Dec. 20, 2001 (DE) 201 20 649.8

(51) Int. Cl. B01L 3/00

(52) U.S. Cl. 422/99; 422/113; 422/242; 215/260

(57) ABSTRACT

The invention relates to a device 51 for closing a plurality of digestion vessels 1 the openings of which are in each case covered by a cover 3, comprising a plurality of positioning spaces 53 for the digestion vessels, the positioning spaces 53 being able to be distributed in a circumferential row R1 and being accessible from outside, and a plurality of closing devices 73 for pressing the covers 3 against the vessels. In order to improve the capacity of the device 51 with regard to the number of digestion vessels 1 further inner positioning spaces 53 are arranged to be offset inwardly with respect to said positioning spaces 53.

### CROSS REFERENCE TO RELATED APPLICATIONS

This Application is a continuation-in-part of co-pending U.S. patent application Ser. No. 10/316,951 filed Dec. 12, 2002, which is a continuation-in-part of co-pending application Ser. No. 10/099,443 filed Mar. 15, 2002.

### BACKGROUND OF THE INVENTION

Field of the Invention

The invention relates to a device for closing a plurality of digestion vessels having covered openings.

To perform an analysis of materials, it is known for one or more materials, e.g. a solid or liquid sample material, to be heated in a digestion vessel, whereby in most cases a pressure above atmospheric is produced in the digestion vessel and this in turn promotes the digestion of the sample material or the like.

A device of this kind is used, for example, for the digestion, elemental analysis or dehydration of the sample material arranged in one or more vessels by heating, whereby the pressure in the vessels rises as a result of the heating.

The heating is preferably effected by irradiation with microwaves in a microwave unit.

A device of this kind is described, for example, in EP 0 830 891 A1. In this known device a plurality of positioning spaces for the digestion vessels are arranged in segment-shaped carriers which have lateral faces forming a wedge configuration such that the carriers possess segment-shaped areas and form in their juxtaposed arrangement a substantially closed ring of segmental carriers. The segmental carriers have a laterally accessible cavity which forms a positioning space for a digestion vessel, an adjustable pressure-applying device for pressing the cover against the associated vessel being in each case arranged in the upper area of the cavity. A resilient pressure-generating means is so integrated in the pressure-applying device that when a pressure exceeding a given value is produced in the digestion vessel a pressure-venting aperture is automatically opened.

In order, firstly, to obtain efficient with a device of the above-mentioned kind and, secondly, to be able to treat a plurality of samples, including different samples, at the same time there is a requirement for a large number of digestion vessels or for large capacity to accommodate sample material.

It is therefore an object of the invention to improve a device of the above-mentioned type with respect to its capacity to accommodate digestion vessels or sample material.

Both solutions according to the invention are based on the recognition that capacity can be obtained by increased utilization of the space for the positioning spaces of the digestion vessels. In both cases more space for positioning spaces is to be created. In this regard space can be created both for a larger total volume of the digestion vessels and for a larger number of digestion vessels.

In one embodiment of the present invention, the object is achieved in that the positioning spaces are arranged in an outer and in an inwardly offset inside the positioning spaces. This embodiment makes it possible also to utilize the space in the device existing inwardly of the outer row for positioning spaces and sample vessels, whereby a substantially larger number of sample vessels in which sample material can be treated simultaneously can be arranged. The efficiency of the device can thereby be increased.

In another embodiment of the present invention, the segmental shape of a floor segment is utilized for at least three positioning spaces. At least three positioning spaces can be very advantageously arranged therein because of the existing segmental shape, it being readily possible to arrange two positioning spaces on the outside and one positioning space on the inside while taking account of the position of the segmental carrier or of a central axis common to all segmental carriers. The number of positioning spaces can be further increased by means of a longer configuration of the segmental shape of the segmental carrier. In this way, radially outward positioning spaces and positioning spaces offset radially to the inside are produced.

In particular, in the case of a device of this kind in which the digestion vessels have a relatively large cover resting on the rim of the digestion vessel considerable forces acting on the cover, which must be absorbed by the closing device, are produced during operation of the device. As a result, an operator must apply large manual forces in order to set the closing device to the desired reload.

It is a further object of the invention so to develop a device in which the covers of the digestion vessels can be closed more easily.

Thus, in accordance with another embodiment of the present invention, an axial bearing taking the form of a roller bearing absorbs the closing forces. A roller bearing is characterized by free running even under comparatively high loads. The roller bearing absorbs even the axial forces arising when setting the comparatively high closing force without losing its free-running characteristics. For this reason the displacement or adjustment force applied by the operator can readily provide the desired closing reload of the cover or covers.

EP 0 830 891 A1 describes a generic configuration of a resilient pressure-generating means acting between a screwing part and a pressure-applying plunger is formed by a stack of metal disc springs arranged one above the other, with the pressure-applying plunger taking the form of a U-shaped component in which is arranged a dome-like cage part which is of metal and forms a Faraday cage for the disc springs. This device has a large number of parts and is structurally large and in particular tall.

GB 2 184 040 A describes a device for closing a pot-like digestion vessel. In this known device the pressure-applying plunger, the screwing part and the resilient pressure-generating means arranged therebetween are contained in a hat-like screwed cover of a pot-like supporting vessel into which is fitted a holding vessel against the cover of which the pressure-applying plunger acts. The screwing part is mounted to be vertically displaceable with a pressure-applying piece in a vertical guide hole in the screwed cover and is in the form of a nut which is screwed on to a pressure-applying piece extending coaxially upwardly from the pressure-applying plunger and having a threaded shaft which passes through a guide hole. Arranged in the annular wall of the hat-like screwed cover in the screwed-on state, at the same level as the upper edge of the supporting vessel, is an internal annular groove from which a venting passage extends radially outwards through the annular wall. This known design has a large number of parts, is structurally large, is complicated and costly to manufacture and is time-consuming to manipulate. There is also the risk that the pressure-applying piece and the nut will move away from one another owing to fouling, for example, as a result of which different pressure ranges will arise when the cover of the holding vessel is opened and closed.

It is an object of the invention to simplify a device of the above-mentioned types and to design it in such away that a small or low construction is obtained. Furthermore, the device is to be improved with respect to its operation. An attempt is also made to reduce the number of separate parts in the device and the amount of material it consumes.

In another embodiment of the present invention, the pressure-applying plunger and the screwing part fit around one another in a socketed arrangement by means of at least one annular wall which may be part of the pressure-applying plunger and which extends upwardly therefrom preferably as an integral part thereof and fits around the screwing part like a socket, or which may be part of the screwing part and extends downwardly therefrom preferably as an integral part thereof and fits around the pressure-applying plunger like a socket. It is also possible for two circumferential walls to be provided of which one annular wall extends upwardly from the pressure-applying plunger and the other extends downwardly from the screwing part and for the annular walls to fit around one another in a socketed arrangement. Not only does this allow guidance and/or radial support to be obtained for the pressure-applying plunger but the interior space between the pressure-applying plunger and the screwing part which holds the resilient pressure-generating means is closed by the at least one annular wall, so that contaminants cannot enter the interior space for the resilient pressure-generating means from the holding space of the holding vessel in case of lifting of the cover of the holding vessel through an over-pressure reaction, nor can other contaminants enter from the surroundings of the device. In this way the interior space is also protected against aggressive treating or digesting chemicals, whereby the movement function of the device is protected and long service life is achieved. If screw-thread guidance is used, positive guidance is provided in both axial directions of movement, so that in case of an adjustment a secure adjustment of the screwing part is achieved even if a certain stiffness is present in the guidance means.

The seal between the pressure-applying plunger and the screwing part can be improved by arranging between the guidance faces which co-operate in a socketed arrangement a seal, preferably an annular seal, which may, for example, be an O-ring which can be inserted in an external annular groove in the part around which the other part fits or in an internal annular groove in the part which fits around the other.

Within the scope of the invention there are many possible ways for the screwing part to be supported against an abutment. Such an abutment may be formed, for example, by a supported disc which fits over a stand plate for the digestion vessel in a space to which microwaves can be applied. If a disc of this kind is open in all directions it can also be used to cover a plurality of circumferentially distributed stand plates for digesting vessels which include the device. In this case the disc may, in a manner known per se, be a turntable which is mounted to be rotatable in the microwaving space together with the stand plates.

The abutment may also be formed by the upper wall of a pressure-absorbing body which delimits a stand plate for a digestion vessel on both sides, at the bottom and at the top. In this embodiment the digestion vessel with the device may be optionally placed on the stand plate and removed therefrom from one side.

The screwing part preferably has an external thread. It can be inserted or be insertable in an abutment supported in a fixed manner, a stand plate for the digestion vessel being located below the screwing part and the pressure-applying plunger and the abutment being preferably formed by the upper wall of a box-like housing having the stand plate.

The pressure-applying plunger can be guided in an axially slidable manner by means of a cylindrical sliding surface running in a hollow cylindrical sliding surface of the screwing part, one or more annular grooves spaced axially apart being arranged in the cylindrical sliding face of the pressure-applying plunger.

The pressure-applying plunger has a U-shaped cross-section and the resilient pressure-generating means is arranged in the recess formed by the U-shaped cross-section.

A co-axial hole is preferably arranged in the pressure-applying plunger. The screwing part has in its upper portion a guidance section for an extension of the pressure-applying plunger formed integrally therewith and arranged thereon. In addition, the screwing part has at its upper end a rotational engagement element, e.g. an open, non-circular socket for a rotary tool in its upper face.

The closing part is a screwing part which is screwed into an abutment arranged above the digestion vessel and is screwable against the cover, the screwing part forming a guide for the valve body and the screwing part being a bush into which the valve body extends, the spring being arranged in the bush. Arranged at the lower edge of the bush is a stop limiting the upward movement of the valve body, which stop is preferably formed by a flange detachably fixed to the lower edge of the bush. The valve body is detachably connected to a valve body base, preferably by a screw connection.

In accordance with another embodiment of the present invention, an abutment may be formed on or supported against the circumferential surface of the digestion vessel. For this purpose the screwing part may be formed by the upper wall of a cap, the annular wall of which can be connected, in its free edge region, for example, to the digestion vessel, e.g. by screws. It is particularly advantageous in this case if an externally threaded ring is fitted on to the circumferential surface of the digestion vessel and is supported against said vessel, preferably against the underside of a flange in the edge region of the digestion vessel, so that the flange absorbs the reaction forces of the device and ensures positioning of the threaded ring by contact. This embodiment is distinguished in particular by its small structure which takes up little space, is handy, consumes little material and is also of low weight.

It is possible and advantageous in all embodiments for a marking or scale to be so arranged between the screwing part or parts attached thereto and the abutment that, with respect to the resilient closing force of the pressure-generating means, the screwing part can be preset in steps or steplessly in such a way that a given opening pressure is obtained in the interior space of the digestion vessel, above which pressure the cover of said vessel automatically lifts and thus opens. This allows the operator to preset desired maximum internal pressures in the holding space of the holding vessel while taking account of the material or materials to be treated.

If, in a device of the present type, the cover of the digestion vessel forms a valve body of a valve which opens at a predetermined internal pressure of the vessel as a result of the elasticity of the resilient pressure-generating means, a relatively large pressure surface is available on the inner face of the cover and a relatively large pre-loading force is therefore required to retain the cover in its closed position on the digestion vessel. Consequently, a relatively large expenditure of force is also required to change the pre-loading force and thereby to adjust the internal pressure value above which the cover is automatically to open. Moreover, it can be regarded as disadvantageous that when such opening of the cover by overpressure takes place the actual point of opening and venting is uncertain and can extend over an indeterminate portion of the circumference or over the entire circumferential portion.

It is a further object of the invention to provide a device in which the digestion vessel is to open and is adjustable with a small expenditure of force. It is also to be achieved that the device is so configured that on venting of the digestion vessel at an internal pressure exceeding a given value the venting takes place at a precisely specified point.

Thus, in accordance with another embodiment of the present invention, the cover has passing through it an outlet channel closed by a valve which automatically opens at an internal pressure in the digestion vessel which exceeds a given value.

Present in the area of the cover in this embodiment is a special valve which automatically opens at an internal pressure in the vessel which exceeds a given value, the cover remaining in its closed position. In this embodiment the size of the opening of the digestion vessel is not relevant; what is relevant is the size of the outlet channel which is substantially smaller than the size of the opening of the digestion vessel or the size of the cover. A substantially lower pre-loading force is therefore required to close the valve, and changes to this pre-loading force can be carried out with a relatively small expenditure of force and with ease of operation, so that the handling convenience of the device according to the invention is substantially improved.

Furthermore, in accordance with this embodiment of the invention, the venting point is restricted to the end aperture of the outlet channel. Because sample material can also escape during a venting process and fouling can thereby take place, measures for preventing or eliminating fouling can be arranged or taken more simply and precisely in this embodiment.

Further refinements of the invention give rise to simple, small and operative structures and serve to prevent fouling of the valve mechanism and to permit precise and easily operated setting of different pressure values at which the valve opens.

### BRIEF DESCRIPTION OF THE DRAWINGS

Advantageous embodiments of the invention will be explained in detail below with reference to a plurality of embodiments and drawings. In the drawings

FIG. 1 shows a vertical section through a vessel arrangement having a device according to the invention for closing a digestion vessel;

FIG. 2 is an enlarged view of the detail marked X in FIG. 1;

FIG. 3 shows a vertical section through a modified vessel arrangement having a device for closing a digestion vessel which is also modified;

FIG. 4 shows a vertical section through a vessel arrangement having a device for closing a digestion vessel modified according to the invention;

FIG. 5 shows a microwave unit with a device according to the invention for closing a plurality of digestion vessels in the irradiation chamber of the microwave unit in a schematic representation;

FIG. 6 shows the half-section VI-VI in FIG. 8 in an enlarged representation;

FIG. 7 shows the half-section VII-VII in FIG. 8 in an enlarged representation;

FIG. 8 shows a schematic top view of the device.

### DETAILED DESCRIPTION OF THE PREFERRED EMBODIMENTS

A pot-like digestion vessel 1 having a circumferential wall 1a which is in the form of a hollow cylinder and is, for example, relatively thin, and a flat bottom wall 1b, is surrounded, and supported in the radially outward direction, by a supporting shell 2 in the form of a hollow cylinder which may extend up to a flange 1c on the upper edge of the circumferential wall 1a, so that the flange 1c rests on the upper end face of the supporting shell 2.

The upper opening of the digestion vessel 1 is to be closed and opened by means of a cover 3 which is, for example, flat and in the form of a stepped cylinder of which, in the embodiment shown, a lower cylindrical cover extension 3a fits into the digestion vessel 1 with little play and is sealed, preferably by an annular seal 4. The latter may be formed by an O-ring 4a which is mounted in an annular groove in the circumferential surface of the cover extension 3a. The shoulder face 3b of the cover 3 thus rests on the flange 1c.

The device, designated as a whole by reference numeral 5, for closing the digestion vessel 1 even when a pressure above atmospheric is present in the interior space 1d of said digestion vessel, consists mainly of three parts, namely a pressure-applying plunger 6, a screwing part 7 at least part of which is arranged above the latter, and a resilient pressure-generating means 8 which is arranged between an upwardly directed supporting face 6a on the pressure-applying plunger 6 and a downwardly directed supporting face 7a on the screwing part 7 and which in functional operation is preloaded with a given compressive force. In the embodiment shown the pressure-generating means 8 comprises a plurality of disc springs stacked on top of one another in opposite directions. The screwing part 7 has at least in its upper portion an external thread 7b with which it is screwed into a threaded bore 9a of an abutment 9 as a screwing part. To allow the screwing part 7 to be turned an element 11 for applying rotation is arranged in its upper face and is intended for a rotary tool which can be positively engaged therewith in rotation. In the embodiment shown the element 11 for applying rotation is formed by a noncircular socket.

To cover the space 12 occupied by the pressure-generating means and thus to protect it from fouling, there is provided an annular wall 7c which surrounds the space 12 and which fits at least partially around the pressure-applying plunger 6 and/or the screwing part 7 in a socketed arrangement. In the embodiment shown the annular wall 7c, which is preferably in the form of a hollow cylinder, extends downwardly from the screwing part 7 as an integral part thereof, fitting at least partially over the preferably cylindrical circumferential surface of the pressure-applying plunger 6 with clearance for movement and thus making the space 12 inaccessible from the sides.

The amount of the vertical overlap a can be sufficiently large to allow a guidance function to be performed between the pressure-applying plunger 6 and the screwing part 7 and/or an annular seal 13 when the device 5 telescopes in a manner which has yet to be described. Preferably arranged in the gap at the overlap is a sealing ring 13a, e.g. an O-ring, which is mounted in an annular groove in the circumferential surface of the pressure-applying plunger 6 and is covered by the inner surface of the annular wall 7c in any telescoped position. The maximum amount of telescoping movement b in the vertical direction is determined in the present embodiment by the distance between the annular wall 7c and the cover 3. If the pressure-applying plunger 6 is formed to have a flange 6b as indicated in ghost lines, the maximum amount of telescoping movement b is determined by the distance from the flange 6b. The flange 6b allows the area over which the pressure-applying plunger 6 acts against the cover 3 to be enlarged and the pressure per unit area effective in operation to be reduced.

The pressure-generating means 8, or the spring discs, may be centered by the inner circumferential surface of the annular wall 7c. However, to avoid the frictional wear which occurs between the two during telescoping, the preferably annular pressure-generating means 8 is centered internally with a small amount of clearance for movement by means of the cantering spigot 6c which in the embodiment shown extends upwardly from the pressure-applying plunger 6 as an integral part thereof and may then engage in, or terminate shortly before, a guide hole 7d present between the supporting face 7a and the element 11 for applying rotation, thus providing additional guidance, which, however, is not absolutely essential, for the pressure-applying plunger 6.

Arranged in the pressure-applying plunger 6, preferably coaxially therewith, is a through hole 14 which may, for example, be lined with an annular wall 15 which may have at its lower end a flange which allows it to be inset into a recess in the pressure-applying face. To allow it to be secured axially in the pressure-applying plunger 6, the annular wall 15 may be a press-fit therein.

The hole 14 may be used to hold functional elements, e.g. sensor elements, which pass through the screwing part 7 and which are functionally connected via said hole to associated control or regulating devices. A temperature sensor, for example, may be provided, which is inserted in the hole 14. A pressure measuring element may also be inserted in the hole 14, the vertical position, or rather the change in position, of which pressure measuring element, on lifting of the cover 3, serves as an indication of the level of the internal pressure prevailing in the digestion space 1d in operation.

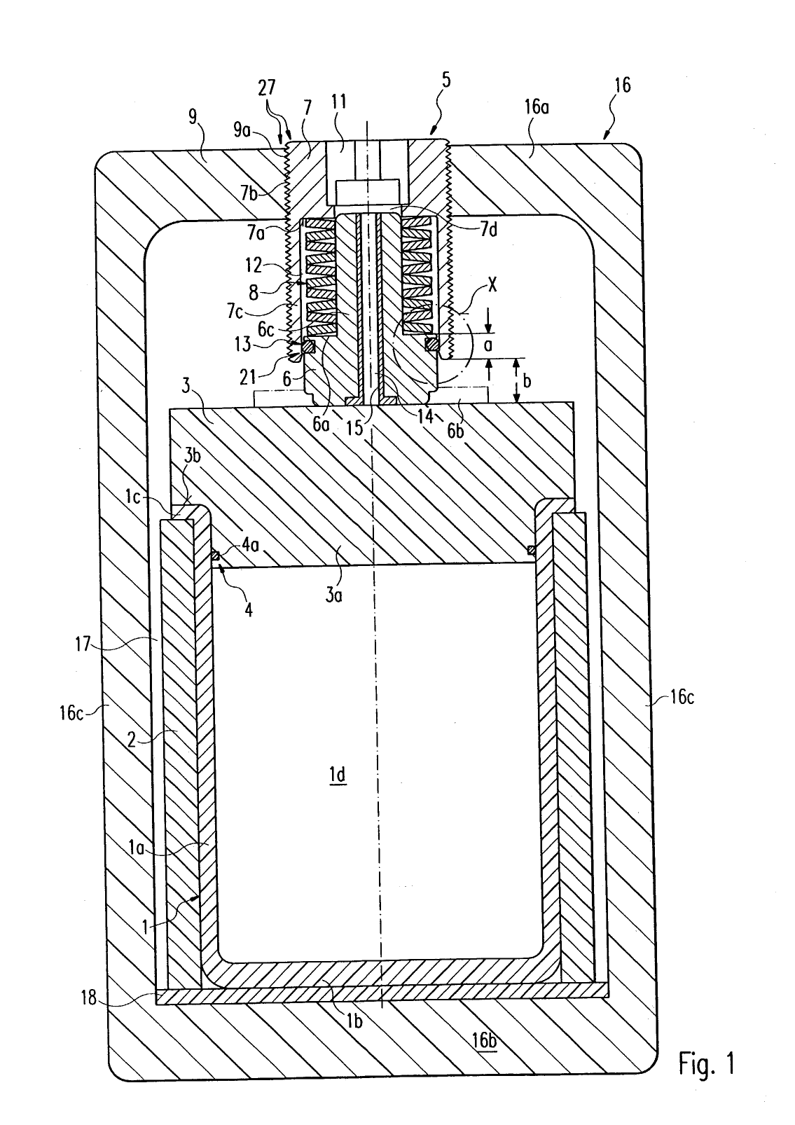

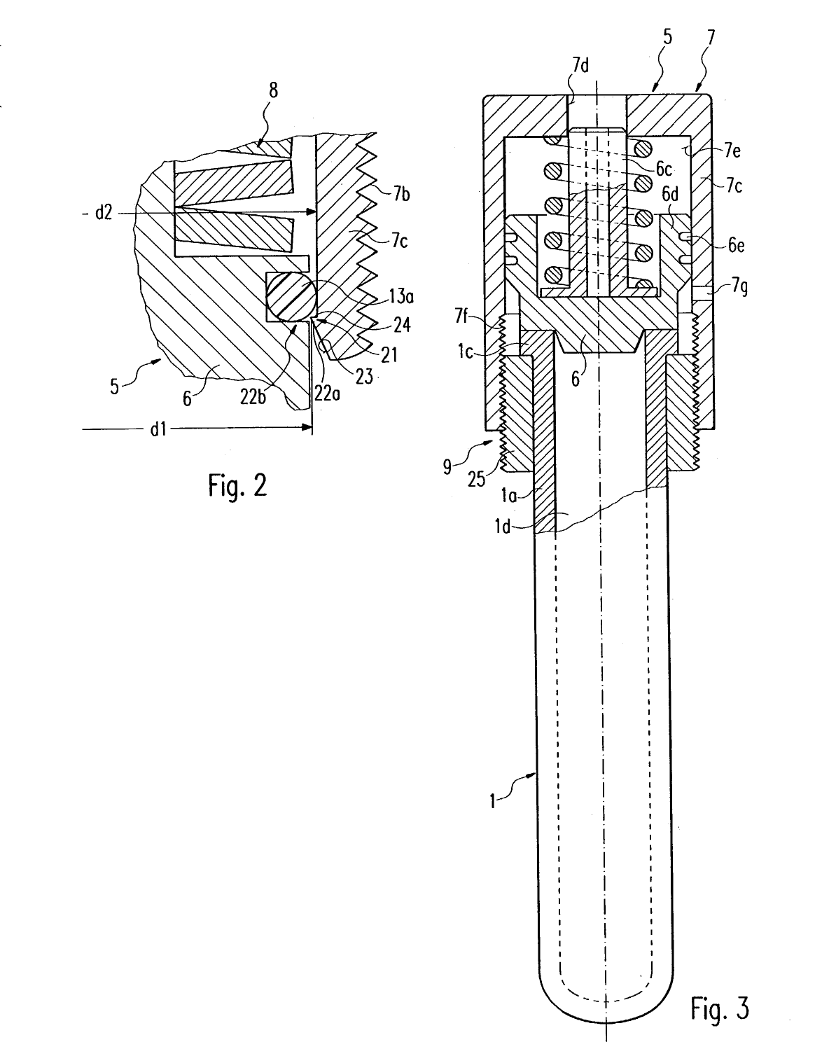

In the embodiment shown in FIG. 1 the abutment 9 is formed by the upper wall 16a of a supporting housing 16 which may be of box-like configuration with a bottom wall 16b and two side walls 16c and forms a holding space 17 for the digestion vessel 1, which space is open at the front or is horizontally continuous and in which said vessel can be installed and removed again from the appropriate side. In its installed state the digestion vessel 1 rests with its bottom wall 1b, which is flat in the embodiment shown, on the bottom wall 16b of the supporting housing 16, whereby the first bottom wall 1b is supported against the internal pressure. An intermediate layer 18, which is preferably made of a thermally insulating material, e.g. plastics material, is arranged between the bottom walls 1b and 16b to reduce the dissipation of heat from the digestion vessel 1.

The resulting relatively great length of the annular wall 7c, which extends downwardly from the screwing part 7, enables the screwing part 7 to have a large range of vertical adjustment and thus to be adapted to digestion vessels 1 of different heights, if the external thread 7b extends at least to the lower end region of the annular wall 7c or, for example, over its entire vertical length.

To prevent the pressure-applying plunger 6 from dropping out of the position in which it overlaps the screwing part 7 when there is no digestion vessel 1 under the device 5, a limiting device 21 is provided between the pressure-applying plunger 6 and the screwing part 7 or the annular wall 7c to limit the maximum extension movement of the pressure-applying plunger 6 and which in the embodiment shown is formed by a stop device having a stop element 22a in the lower end portion of the annular wall 7c. The opposing stop element 22b is preferably formed by the sealing ring 13a which projects somewhat from the circumferential surface of the pressure-applying plunger 6 in the radial direction and can thus form the opposing stop element 22b without the need for any special opposing stop element. As a result, the sealing ring 13a performs a sealing and stopping function. The stopping element 21 is formed by an internal annular bead on the inner circumferential surface of the annular wall 7c. To allow a small clearance for movement or sliding, the diameter of the annular bead is made larger than the diameter of the pressure-applying plunger 6, thus enabling the latter to move in the annular bead. The internal diameter d1 of the annular bead is made somewhat smaller than the internal diameter d2 of the rest of the annular wall 7c, thus enabling the internal bead to be formed. At the same time, the internal diameter d2 is made only sufficiently large for the sealing ring 13a to form a resilient seal against the inner circumferential surface 7e of the annular wall 7c. In the embodiment the outer flank of the stop element 22 or the annular bead is formed by an oblique or rounded lead-in face 23. The inner flank 24 is the face of a step which preferably extends approximately at right angles to the center axis of the pressure-applying plunger 6. In the embodiment the internal annular bead is pointed in cross-section, producing a pointed annular edge. The sealing ring 13a will thereby be sheared off if the pressure-applying plunger 6 is forcibly extracted from its socketed connection and protection is provided against dismantling in view of the damage that would be caused to the sealing ring 13a.

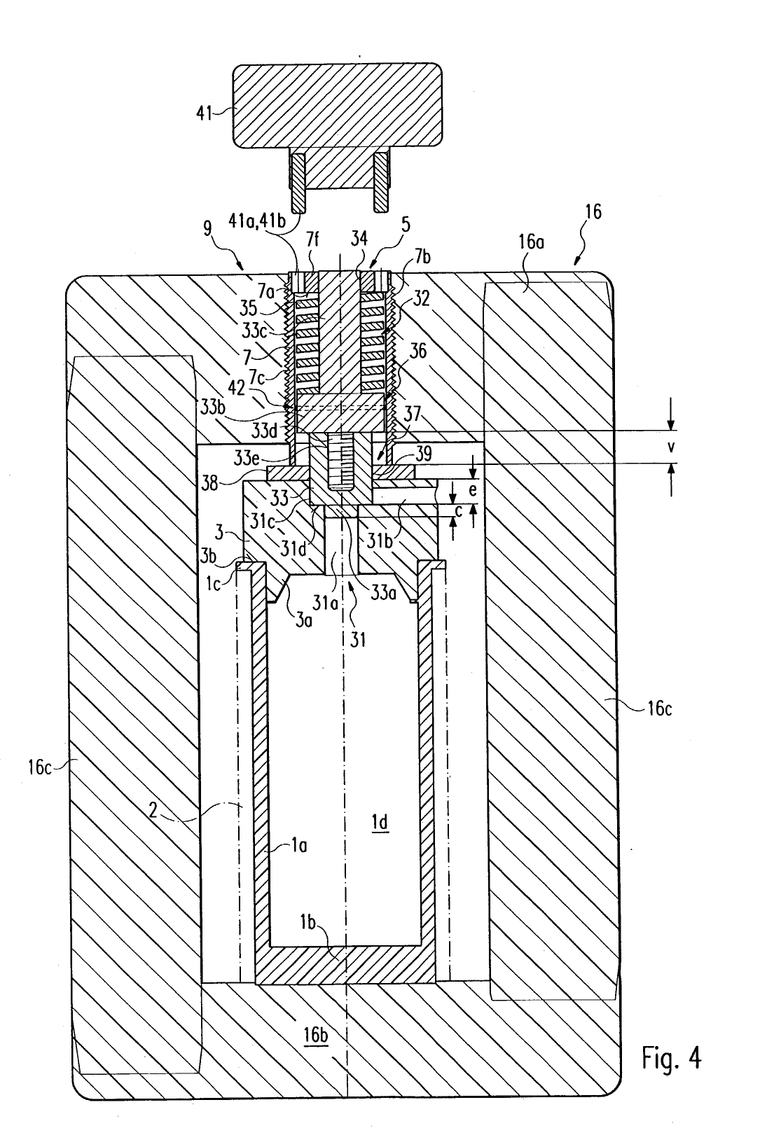

In the embodiment shown in FIG. 3, in which the same or comparable parts are designated by the same reference numerals, the screwing part 7 with its annular wall 7c has been made so large that it fits around at least the upper edge portion of the digestion vessel 1 like a cap and is screwed thereto, so that the circumferential wall 1a or the flange 1c or an optionally present supporting shell 2, to any of which the annular wall 7c may be screwed, forms the abutment 9. In the embodiment a supporting ring 25 is fitted on to the digestion vessel 1, preferably in the upper region of the digestion vessel 1, and in particular is arranged to rest against the flange 1c and to be connected to the outer circumferential surface of the digestion vessel 1, e.g. by pressing on or bonding. A connection of this kind ensures that the forces applied to the abutment are transmitted to the digestion vessel 1. If the supporting ring 25 rests against the flange 1c a connection to the outer circumferential surface can be omitted as the flange 1c absorbs the forces from the abutment. However, in this case too it is advantageous for the supporting ring 25 to be retained on the digestion vessel 1, e.g. by bonding or pressing on, so that it cannot be lost.

The screw connection between the screwing part 7 and the supporting ring 25 preferably comprises an internal thread 7f in the end portion of the annular wall 7c and a matching external thread on the supporting ring 25.

In the two embodiments described above, the pressure-applying plunger 6 can form the cover 3, as shown in FIG. 3. In the embodiment shown in FIG. 1 the cross-sections of the pressure-applying plunger 6 and the screwing part 7 would have to be enlarged as appropriate to allow the pressure-applying plunger 6 to form the cover 3. The hole 14 would also have to end at a distance from the end of the pressure-applying plunger 6 which faces towards the digestion vessel 1.

In all the embodiments it is also possible for the pressure-applying plunger to have a U-shaped configuration in cross-section as shown in FIG. 3 and thus to be provided with a circumferential wall 6d which, owing to its axial length, ensures that the pressure-applying plunger 6 is guided in such a way as to be secure against tilting and which can also ensure sufficient sealing. It is also advantageous for one or more grooves 6e spaced at an axial distance from one another to be arranged in the circumferential surface of the circumferential wall 6d, which grooves both improve the seal and, in view of the differing thermal expansions, prevent in particular any harmful tensions from arising in the fit when the material of the pressure-applying plunger, in particular at fairly high digestion temperatures, is relatively soft or yielding.

In the embodiment shown in FIG. 3 the resilient pressure-generating means 8 is formed by a helical spring which is supported against the upper wall of the screwing part 7 and bears against the pressure-applying plunger 6, at the bottom of a recess in the present case.

In the embodiment shown in FIG. 3, too, there may be provided a cantering spigot 6c which likewise is preferably circular in cross-section and can be guided longitudinally or vertically in the guidance hole 7d in the upper wall of the cap-like screwing part 7 with clearance for movement. At its lower end the cantering spigot 6c preferably has a flange to reduce the pressure per unit area, against which the pressure-generating means 8 can bear.

In all the embodiments it is advantageous to apply a marking between the screwing part 7 and a part positioned on the digestion vessel 1 or on the cover 3 or on the pressure-applying plunger 6, which marking shows the axial position of the screwing part 7 with respect to the positioned part and preferably allows the screwing part 7 to be preset in a defined manner. The marking may, for example, be formed by a scale and a pointer which are located in each case on one of the two parts to be compared. In the embodiment according to FIG. 1 the marking 27 can be arranged, for example, on the upper faces of the screwing part 7 and of the abutment 9, preferably close to or at the threaded joint in the screwed assembly, e.g. in the form of an annular scale on the upper wall 16a and a pointer on the screwing part 7.

In the embodiment shown in FIG. 3 the marking 27 may be formed, for example, by the front end of the cantering spigot 6c and the lower or upper edge of the guide hole 7d. It is also possible for the markings or scale divisions to be applied to the inner wall face of the guide hole at axial distances from one another, which allow the position of the cantering spigot 6c and therefore the open or closed position of the pressure-applying plunger 6, and optionally also of the cover, to be seen or read off against the free end of the cantering spigot 6c.

In the embodiment shown in FIG. 1 the digestion vessel 1 is made of a corrosion-resistant material, in particular plastics material and preferably polytetrafluoroethylene (PTFE). The other parts of the digestion vessel 1 including the supporting housing 16 are made preferably of material which is permeable to microwaves and preferably plastics material. This may also be true of the device 5. In the embodiment, the spring forming the resilient pressure-generating means 8 or the resilient elements are made of metal, in particular of spring steel or special steel. The screwing part 7 can also be made of metal, e.g. special steel, in which case it acts as a Faraday cage with respect to the spring. Operation is improved if the cage has a polished surface and its edges are rounded. It is also advantageous for the dimensions of the cage, i.e. its diameter and axial length, preferably to be sized at between a quarter and one complete wavelength of the microwave radiation used. In addition, the surface of the metal cage may be coated with a material, such as e.g. PTFE, which is resistant to corrosive chemicals, to prevent the surface of the metal from being attacked by the chemicals.

For a digestion process a sample material is placed in the digestion vessel 1 and the digestion vessel 1 is closed with the device 5. As this is done the screwing part 7 is screwed in (FIG. 1) or on (FIG. 3) sufficiently far for the resilient pressure-generating means 8 to exert a closing force which corresponds to a given internal pressure. If the internal pressure rises in operation to more than a given value or the set value, the cover 3 or the pressure-applying plunger 6 automatically opens, in which case the pressure-generating means 8 yields and the internal pressure can escape. In this case the device 5 acts as a pressure-release valve, the opening pressure being adjustable by screwing in the screwing part 7.

The embodiment shown in FIG. 3, where the same or comparable parts are designated by the same reference numerals, differs from the embodiment described above with respect to a plurality of arrangements.

Firstly, the abutment 9 is not part of a supporting housing 16 which holds the entire digestion vessel 1 but of a small cap-like supporting housing 22 which, although it similarly transmits the reaction forces to the digestion vessel 1, fits around only the upper portion of the digestion vessel 1, is supported directly or indirectly against this upper portion and therefore transmits the reaction forces to this portion of the digestion vessel 1. The direct or indirect connection to the upper portion of the digestion vessel 1 is effected by a screw connection. A radial venting aperture 7g is provided in the annular wall 7c above the flange 1c or the supporting ring 25. The bottom wall 1b of the preferably cylindrical holding vessel 1 preferably has a hemispherical configuration, thus enabling the wall to be evenly stressed.

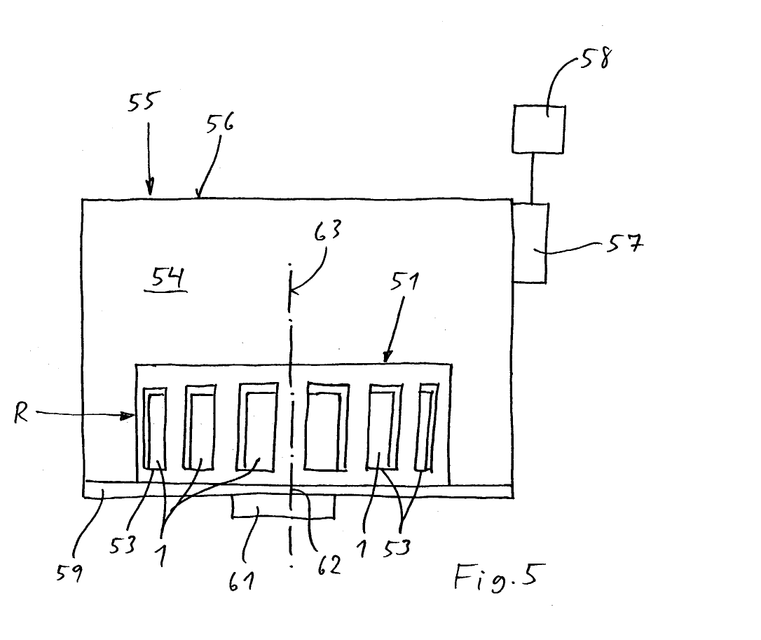

In the embodiment shown in FIG. 4, in which the same or comparable parts are designated by the same reference numerals, the digestion vessel 1 (apart from the cover 3) and the supporting housing 16 can have substantially the same or in principle the same configuration. The important differences are the following.

Firstly, the screwing part 7 which forms a closing part is made sufficiently long for it to extend as far as the cover 3 and therefore to be able to be braced against the cover 3, whereby the digestion vessel 1 can be closed in a tightly-sealed manner and the cover 3 rigidly closed.

Secondly, an outlet channel 31 which is closed by a valve 32 is arranged in the cover 3, the valve 32 opening automatically if the internal pressure in the digestion vessel 1 exceeds a predetermined value. The outlet channel 31 can have an angled configuration, the first outlet channel section 31a which leads from the interior space 1d preferably extending coaxially in the cover 3 and passing over into a laterally extending outlet channel section 31b in the upper portion of the cover 3. A valve body 33 is used to close the outlet channel 31 in an arrangement comparable to the pressure-applying plunger 6 of the previous embodiment. The valve body 33, which is, for example, cylindrical, closes the outlet channel 31 with its bottom face; in the embodiment said valve body fits into an upper widened portion 31c of the channel in the cover 3 which has a step face 31d forming, for example, a right angle, which step face forms a stop for a downwardly directed movement of the valve body 33. The lateral outlet channel section 31b branches off from the widened channel section 31c above the step face 31d. A spigot 33a which is dimensioned to fit the outlet channel section 31a with clearance for movement, and which closes the outlet channel section 31a with small clearance for movement, may project from the underside of the valve body 33. The length c of the spigot 33a is shorter than the length e of the widened portion 31c of the channel.

The valve body 33 extends downwardly from a valve body base 33b which has an enlarged cross-section and which is dimensioned to fit, with clearance for movement, the internal cross-sectional shape and size of the screwing part 7, which in this area has a hollow cylindrical configuration, and thus is guided to be vertically displaceable therein. A stud 33c can extend concentrically upwardly from the valve body base 33b, which stud can for example be formed integrally with the valve body base 33b and passes through an upper end wall 7f of the screwing part 7 via a hole 34 and can close said hole at the upper end or project beyond it. Located between the end wall 7f and the valve body base 33b is a spring 35, e.g. a helical spring, surrounding the stud 33c, which spring is supported against the end wall 7f and preloads downwardly the closing part designated as a whole by reference numeral 36. The upper end of the stud 33c can form with the upper end face of the screwing part 7 an indicator for the pressure prevailing at any time within the movement range of the length c, or for the opening pressure.

The closing part 36 is formed preferably in two parts with the valve body 33 and is detachably connected to the latter by means of a screw connection. In the embodiment a threaded pin 33d projects downwardly from the valve body base 33b, on to which pin the valve body 33 is screwed by means of a threaded bore 33e and is thereby retained detachably and exchangeably. For the purpose of adaptation to different covers 3 a plurality of different valve bodies 33 adapted in each case to the associated cover 3 and which can be exchangeably attached to the valve body base 33, can be provided.

A stop 37 to limit the downward movement of the closing part 36 can be arranged at the lower end of the screwing part 7. In the embodiment a disc flange 38 is preferably detachably fixed to the lower portion of the screwing part 7, which disc flange has a coaxial bore 39 by means of which the valve body 33 passes through the disc flange 38 and can also, for example, be guided therein, and projects downwardly beyond the disc flange 38.

For a digestion process the filled digestion vessel 1 is placed below the valve body 33 and the screwing part 7 is screwed manually against the cover 3 using a rotation tool 41 which is positively connectable by means of a non-circular socket connection or two socket connections 42 to the upper end of the screwing part 7, whereby the digestion vessel 1 is rigidly closed with an axial loading. In this case the screwing part 7 bears against the cover 3 with its disc flange 38, the pressure per unit area being lower because of the relatively large area of the disc flange 38. When the screwing part 7 is moved towards the cover 3 the valve body 33 contacts the valve seat 33a, and the valve body base 33b or the closing part 36 is preloaded by the reload distance V against the spring 35, the spring 35 pressing against the valve seat with a given reload, e.g. 200 N/mm. In the embodiment the first outlet channel section 33a has a diameter of approx. 8 mm.

In the embodiment the valve body 33 is made of a corrosion-resistant material e.g. ceramic or plastics material, preferably PTFE. The valve body base 33b can be made e.g. of stainless steel or ceramic material. The screwing part 7 and the disc flange 38 are made preferably of corrosion-resistant metal, in particular special steel. This also applies to the spring 35, which may be made e.g. of spring steel.

To protect the interior space of the screwing part 7 against fouling an annular seal 42, preferably comprising a sealing ring 42a mounted in an annular groove in one component, in particular in the valve body base 33b, is arranged between the valve body base 33b and the wall of the screwing part 7 and cooperates sealingly with the opposing wall of the other component. An annular seal 42 of this kind can also be provided between the disc flange 38 and the valve body 33.

For a digesting operation the vessel arrangement is placed in a microwave oven and microwaves are applied thereto. If the internal pressure in the digestion vessel 1 exceeds a predetermined value because of internal heating and, if applicable, a reaction of the material contained in the digestion vessel, the valve body 33 automatically lifts from the valve seat, whereby the outlet channel 31 is opened and the internal pressure is limited by means of venting through the outlet channel 31.

In all the embodiments it is advantageous for the device 5 or the valve 32 to be configured to be so adjustable that the cover 3 or the valve 32 opens at different pressures in the digestion vessel 1. By this means the opening pressure and therefore the pressure effective during treatment or digestion of the material can be changed and adjusted to a predetermined requirement. This can be achieved, for example, in that a plurality of resilient pressure-generating means 8 or a plurality of springs 35 of differing compressive force which are optionally usable by exchange, are provided. The device 5 or the valve 32 can thereby be adapted to opening pressures of different values.

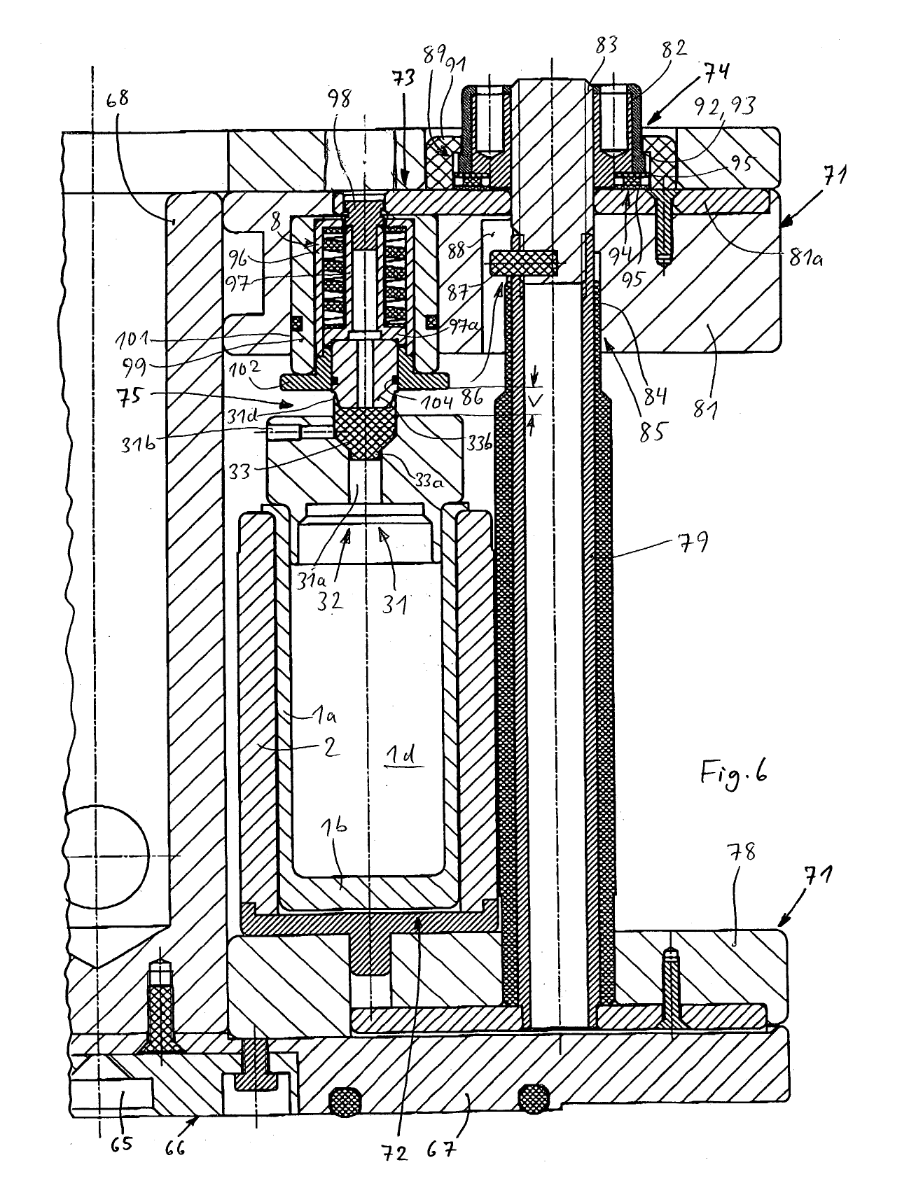

The embodiment according to FIGS. 5 to 8, in which the same or comparable parts are designated by the same reference characters, shows a device 51 for receiving a plurality of digestion vessels 52 on one vessel positioning space 53 in each case in the radiation chamber 54 of a microwave unit 55, which has a housing 56 to be opened and closed by means of a door or the like and which surrounds the radiation chamber 54. Associated with the microwave unit 55 is a microwave generator 57 and an electronic control arrangement 58 for controlling the microwave unit 55.

A microwave unit 55 as described above is known as such and therefore does not need to be described further.

In the present embodiment the device 51 can be a rotor which is derivable about its vertical central axis 63 in its position standing e.g. on the floor 59 of the housing 56 by a drive 61 arranged e.g. below the irradiation chamber 54 and having a drive shaft 62 passing through the floor 69. A socket connection having on the underside of the device 51 a non-circular socket 65 in which the drive shaft 62 engages positively can serve as the rotary connection to the rotor.

The main components of the rotor, which is designated as a whole by R, are a rotor support 66, which comprises a baseplate 67 and a central column 68 extending vertically upwards therefrom, and a plurality of carrier segments 71 provided in each case for a plurality of digestion vessels 1 each of which is located on an associated stand plate 72. The carrier segments 71 have in addition closing devices 73 for closing the covers 3, which closing device 73 is vertically displaceable and adjustable preferably by means of an adjusting device 74, an overpressure venting device 75 being provided and being associated in particular with the closing device 73, which venting device 75 automatically opens and vents if the internal pressure in the digestion vessel 1 exceeds a given value.

When seen from the top the carrier segments 71 have the form of a triangle, e.g. with truncated corners, their adjacent side faces 76 approximately bounding vertical planes which extend longitudinally through the central axis 77 of the device 51. The radial dimension a corresponds approximately to the radial distance of the central column 68 from e.g. the circular circumference of the baseplate 67. The width of the carrier segments 71 oriented in the circumferential direction of the device 1 is such that the substantially contiguous carrier segments 71 form a ring extending around the central column 68, their radially inward ends abutting the central column 68. This makes possible simple handling when fitting the carrier segments 71 to the device 1, since the former can be inserted against the central column 68 and side-by-side, so that the ring automatically closes piece by piece.

In the embodiment the identical carrier segments 71 consist of a plate-like base 78, a support column 79 rigidly connected to the base 78 and arranged centrally thereon, and an e.g. plate-like upper part 81 which is maintained in a vertically displaceable manner in the support column 79 and is guided by the latter. The closing device 73 and the adjusting device 74 are also associated with the upper part 81.

Arranged on the base 78 in the embodiment are three stand plates 72 for three digestion vessels 1 which can be arranged in an evenly distributed manner. A closing device 73 and adjusting device 74 can be associated with and placed above each stand plate 72 or each digestion vessel 1 standing thereon, which closing device 73 and adjusting device 74 can be arranged on the upper part 81. In the present embodiment a common closing device 73 and adjusting device 74 are present for all the digestion vessels 1 of each carrier segment 71, a separate resilient pressure-generating means and a separate venting device 75 being associated with each digestion vessel 1. In the embodiment the venting devices 75 are integrated into the common closing device 73, so that they are components of the closing device 73. In this embodiment, as in the embodiment according to FIG. 3, the valve body 33 also forms part of the venting device 75 and of the closing device 73. An important element of the venting device 75 and of the closing device 73 is the resilient pressure-generating means 8 which, firstly, indirectly presses the cover 3 with the closing force against the digestion vessel via the valve body 33 and, secondly, yields and is compressed by an excessive internal pressure, so that the valve body 33 unblocks the outlet channel 31b and the overpressure can be vented.

In the embodiment according to FIGS. 5 to 8 the upper part 81 replaces the screwing parts 7 associated with each digestion vessel 1 as a common screwing part which is vertically adjustable by screwing up and down of a nut 82 screwed on to a thread 83 on the upper end portion of the support column 79. In this case the support column 79 forms a guide 85 formed by a guide bore 84 for the upper part 81. By means of an anti-rotation device 86 acting between the support column 79 and the upper part 81 and permitting vertical displacement of the upper part 81, the upper part 81 is positioned with respect to the digestion vessels 1 in the circumferential direction also. The anti-rotation device 86 can be formed by a securing pin 87 projecting radially from the support column 97 and engaging in a vertical guide groove 88 in the wall of the guide bore 84. The upper part 81 is connected to the nut 82 by an axially rotating joint 89 and is therefore retained axially on the nut while ensuring the rotatability of the latter. In the embodiment this is achieved by means of a retaining ring 91 which is fixed to the upper face of the upper part 81 and an inner annular shoulder 92 of which engages above an upwardly oriented shoulder face 93 of the nut 82. Arranged between the nut 82 and the upper part 81 is an axial bearing 94 which is preferably formed by a roller bearing, e.g. a needle roller bearing having two bearing discs 95 and roller bodies arranged therebetween. A bearing 94 formed by a roller bearing facilitates screwing of the nut 82 when closing the vessel because of the low friction between the nut 82 and the upper part 81. Incorporated below the axial bearing 94 is a plate 81a made of resistant material, which can be e.g. metal or steel. The plate 81a is so configured, e.g. by forming, that it cannot be substantially heated by the microwaves.

In the embodiment according to FIGS. 5 to 8, too, the resilient pressure-generating means 8 comprises a compression spring 35, e.g. a helical spring, surrounded by a sleeve or pot-shaped spring housing 96. Passing through the spring 35 with free play is a connecting bush 97 which is connected at its upper end to a plug 98 which can be an optical indicator of the internal pressure contained in the digestion vessel 1. The spring housing 96 is located in a further housing 99 which is inserted in a downwardly open recess 101 in the upper part 81, is retained therein e.g. by a press fit and is sealed by means of an annular seal. Arranged and retained at the lower end of the further housing 99 is a flange 102 which surrounds an upper section 33b of the valve body 33 by means of a vertical guide which has free play and is sealed by an annular seal 104, e.g. an O-ring, which is seated in an annular groove in the valve body base 39b or in the flange 102. The spring 35 bears upwardly against the upper part 81 indirectly via a flange of the spring housing 96, and acts downwardly against a flange 97a of the connecting bush 97. A small difference between the configuration of the valve 32 and that according to FIG. 3 consists in the fact that the valve body 33 fits with a conical stepped face 31d into a correspondingly conical valve seat of the cover 3.

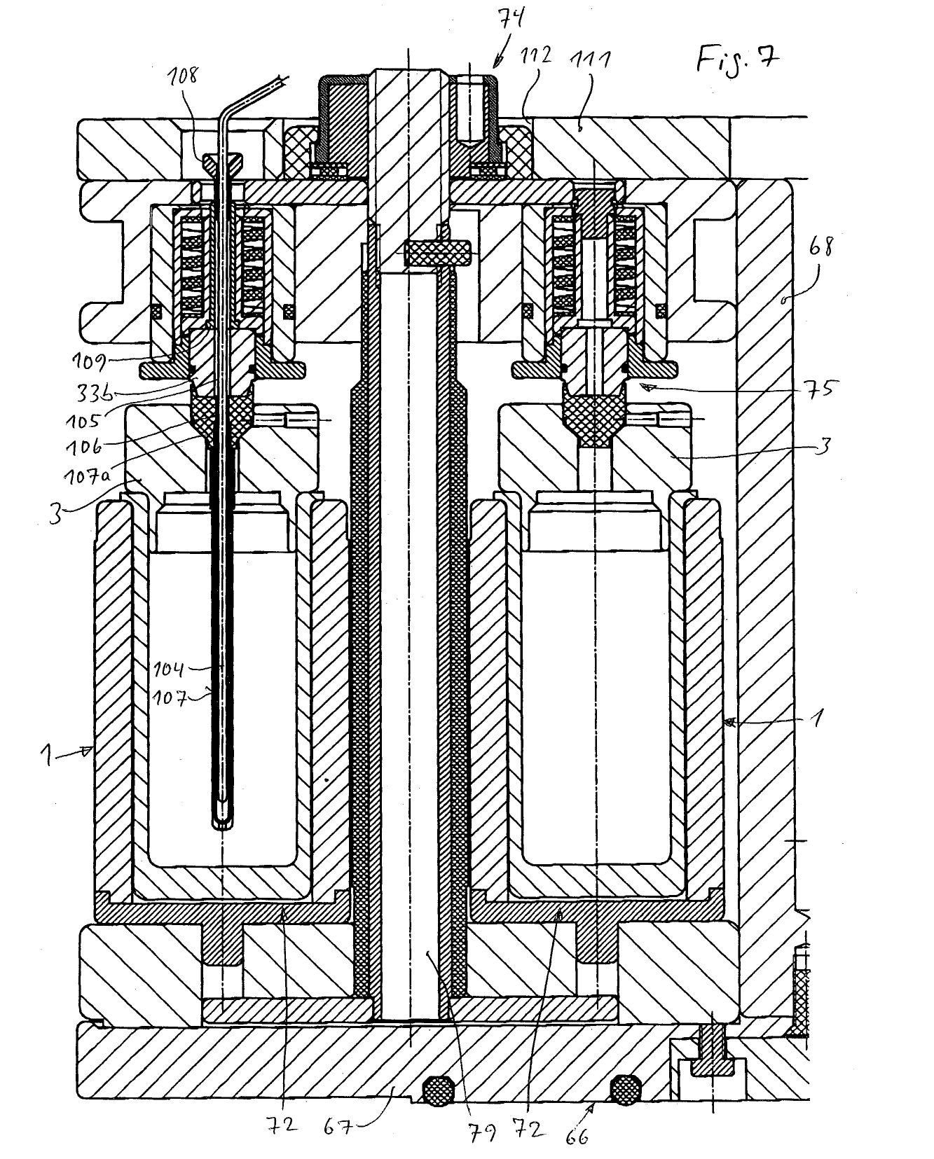

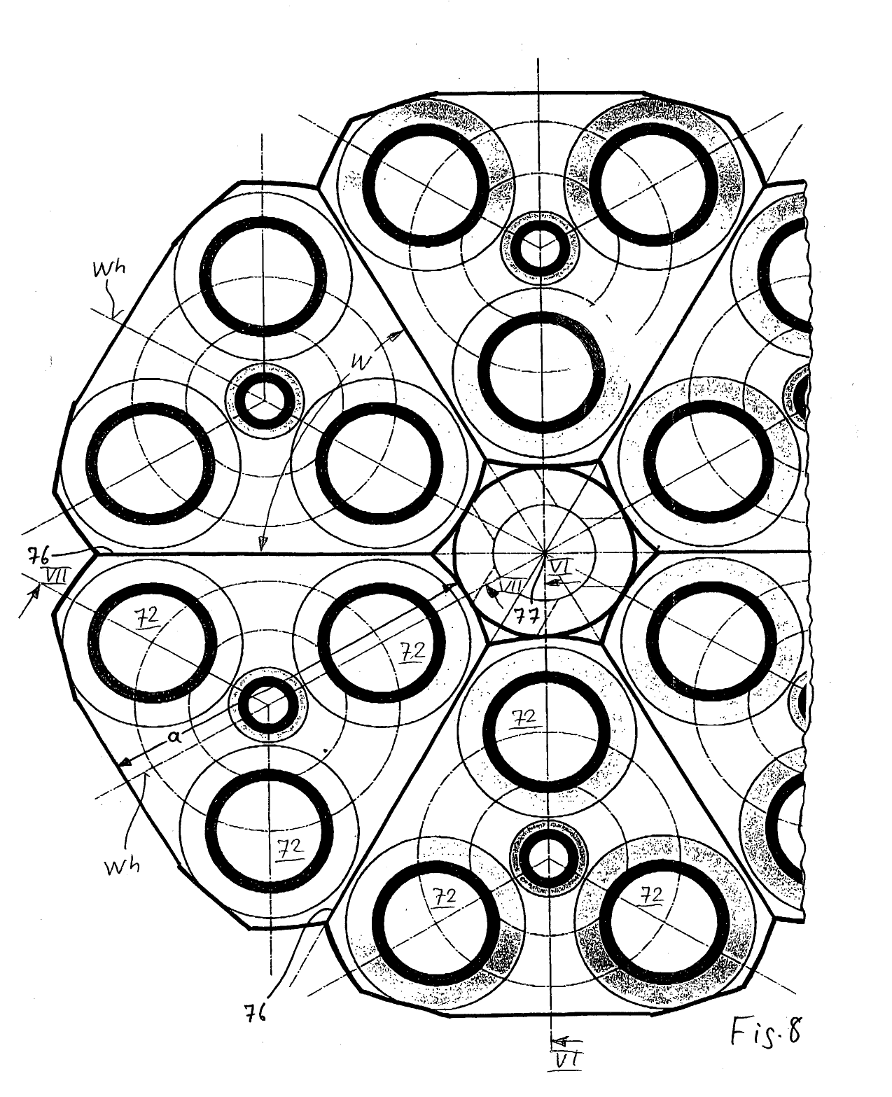

The embodiment according to FIG. 7 differs from that according to FIG. 6 only in that a temperature sensing device 104 is provided in the form of a pin-shaped probe which passes through the upper part 81 in the area of the connecting bush 97, of a through-bore 105 in the valve body base 33b and of a through-bore 106 in the valve body 33. The temperature sensing device 104 can be surrounded by a sleeve-like protective cap 107 which is inserted and retained in a widened portion 107a of the through-bore in the valve body 33. To assemble the temperature sensing device 104 the plug 98 is removed and can be replaced by an insertion sleeve 108 which is inserted in an inner sleeve 109 which surrounds with clearance the temperature sensing device 104 and a connecting lead thereof and is inserted in the connecting bush.

For a digestion process the digestion vessel 1 can be charged with sample material outside the irradiation chamber 54. The digestion vessels 1 can be placed in the carrier segments 71 and positioned with them on the rotor carrier or, in the case of carrier segments 71 located on the rotor carrier 66, can be installed therein. The upper part 81 is then lowered on to the covers 3 or on to the valve bodies 33 by screwing down the nut 85. By a specified screwing down against the loading of the spring 35 an opening pressure selectable within the range of the adjustment travel v can be preselected, above which pressure the valve automatically opens. The upper part 81 can also be moved directly downwards against the cover 3 by the flanges, whereby a maximum opening pressure is set.

Otherwise, the venting device 75 operates as in the embodiment according to FIG. 3.

The configuration according to the invention yields a number of advantages.

One of the advantages is that the number of positioning spaces 53 can be increased. This advantage affects the device 51 in that in the configuration according to the invention the arrangement of digestion vessels 1 can be disposed not only in one circumferential row R1 but also in a second circumferential row R2 offset inwardly with respect to the former. The space present inside the outer circumferential row RI can therefore also be utilized for positioning spaces 53 or digestion vessels 1. Access to the inner positioning spaces 53 is ensured e.g. by moving past and above the outer positioning spaces 53. In the embodiment access to the inner positioning spaces 53 is ensured in that the carrier segments 71 can be installed and removed.

The arrangement according to the invention of a plurality of positioning spaces 53 or digestion vessels 1 on the carrier segments 71 leads to a substantial simplification of handling when loading the carrier segments 71, which can be located outside or inside the device 51, and/or when installing the previously loaded carrier segments 71 in the device 51. Said carrier segments 71 can likewise be easily and simply positioned in the device 1 since the installing movement is limited inwardly by abutment against the central column 68 and further carrier segments 71 can be simply and precisely positioned through the delimitation of the support column 68 and the lateral bounding by an adjacent carrier segment 71.

A further simplification of handling with regard to setting the maximum internal pressure lies in the fact that a plurality of the digestion vessels 1 can be simultaneously closed and adjusted and/or opened again.

The above-described positioning of the carrier segments 71 in the device 1 on the basis of the segment shape is ensured if the base 78 and/or the upper part 81 is/are wedge-shaped in the above-described manner. This description of the shape therefore also applies to the upper part 81.

In the embodiment according to FIG. 7 a temperature sensing device 104 need not be allocated to all digestion vessels 1, since a digestion function in relation to temperature is not always desired. Within the scope of the invention, however, all the venting devices 95 or pressure-applying devices can be so configured that a temperature sensing device 104 can optionally be installed.

In the embodiment according to FIGS. 6 and 7, as in the embodiments described previously, the spring housing 96 and the connecting bush 97 consist of metal, whereby they protect the spring 35 made of spring steel from heating by the microwaves. Otherwise, the individual parts of the device 1 are made of plastics material in this embodiment also.

Designated by reference numeral 111 is a cantering disk which rests on the carrier segments 71 and has holes 112 fitting around the nut 82, which has engagement elements for a rotary tool, or around the retaining ring surrounding said nut.

The side faces 76 of the base 78 and/or of the upper part 81 preferably include an angle W of 60°. The six carrier segments 71 present in the embodiment illustrated are identical.

1. A device for closing a plurality of digestion vessels the openings of which are in each case covered by a cover, comprising
a plurality of positioning spaces for the digestion vessels, the positioning spaces being able to be distributed in a circumferential row and being accessible from outside, and
a plurality of closing devices for pressing the covers against the vessels, wherein
further positioning spaces are arranged to be offset inwardly from said positioning spaces.

2. A device according to claim 1, wherein
the inner positioning spaces are located on a diametrical line which extends between the two adjacent outer positioning spaces.

3. A device according to claim 1, wherein
at least two outer positioning spaces and at least one inner positioning space are arranged on one carrier segment.

4. A device according to claim 3, wherein
the carrier segment has a common closing device for its positioning spaces.

5. A device according to any of claims 1 to 4, wherein
in each positioning space a resilient pressure-generating means (8) for pressing the cover against the vessel is provided and/or a venting device which automatically opens at an internal pressure which exceeds a given value is provided.

6. A carrier segment for closing a plurality of digestion vessels the openings of which are covered in each case by a cover, comprising a positioning space above which is arranged a closing device for pressing the cover against the vessel, two opposed side faces of the carrier segment extending in a wedge configuration, characterized in that the carrier segment has at least three positioning spaces, two positioning spaces being arranged on each side of a median of the wedge configuration in the divergent portion of the carrier segment, and one positioning space being arranged in the narrow portion of the carrier segment, the carrier segment having a support column which extends upwardly between the positioning spaces and supports the closing device.

7. A carrier segment according to claim 6, wherein
a common closing device is provided for the digestion vessels.

8. A carrier segment according to claim 6 or 7, wherein
the support column links a base carrying the positioning spaces and an upper part comprising the support device, the base and/or the upper part having a wedge-shaped configuration.

9. A device for closing a plurality of digestion vessels the openings of which are in each case covered by a cover, comprising a plurality of positioning spaces for the digestion vessels, the positioning spaces being distributed around a central support column, wherein
a common closing device is provided for the digestion vessels which is vertically displaceable by means of a screwing part which is journalled in the end portion of the support column is provided, and wherein
a roller bearing which takes up an axial screwing force is arranged between the common closing device and the screwing part.

10. A device according to claim 9, wherein
the screwing part is a nut which is screwed on to the support column.

11. A device according to claim 10, wherein
the closing device has a horizontal disc of a more resistant material than the other material of the closing device and the roller bearing is arranged between the disc and the screwing parts.

12. A device for closing a pot-like digestion vessel the opening of which is covered by a cover, comprising
a pressure-applying plunger,
a screwing part arranged coaxially with the pressure-applying plunger,
a resilient pressure-generating means arranged between the pressure-applying plunger and the screwing part, wherein
the screwing part and the pressure-applying plunger fit around one another in a socketed arrangement.

13. A device according to claim 12, wherein
an annular wall which fits over the pressure-applying plunger and which is preferably integrally connected to the screwing part extends from the screwing part.

14. A device according to claim 12 or 13, wherein
an annular seal is arranged between the annular wall and the pressure-applying plunger.

15. A device according to claim 14, wherein
the annular seal is formed by a sealing ring of resilient material which is mounted in an annular groove in the inner circumferential surface of the annular wall or in the outer circumferential surface of the pressure-applying plunger.

16. A device for closing a pot-like digestion vessel the opening of which is covered by a cover, comprising
a pressure-applying plunger,
a screwing part which fits over the pressure-applying plunger in the manner of a cap and which has in its lower edge portion a screw thread by means of which it can be screwed to an abutment which surrounds the digestion vessel, wherein
the abutment is formed by a supporting ring which is fixed to the digestion vessel at the circumference thereof.

17. A device according to claim 16, wherein
the digestion vessel has a flange at its edge and the supporting ring is fastened to the outer circumferential surface of the digestion vessel and/or fits under the flange and/or is formed on the flange.

18. A device according to claim 16 or 17, wherein
the resilient pressure-generating means is formed by one or more disk springs stacked one on top of another or by a helical spring.

19. A device according to claim 16 or 17, wherein
a position-indicating marking is arranged between the screwing part and the abutment.

20. A device for closing a pot-like digestion vessel, the opening of which is closable by a cover which preferably can be braced against the cover by means of a closing part, wherein
the cover has passing through it an outlet channel which is closed by means of a valve which automatically opens the outlet channel at an internal pressure in the digestion vessel which exceeds a given value.

21. A device according to claim 20, wherein
the outlet channel extends axially, in particular coaxially, from inside to outside and the valve has a valve body which is larger than the outlet channel and is preloaded against the edge of the outlet channel by means of a spring.

22. A device according to claim 21, wherein the edge is formed by the stepped face of a widened portion of the outlet channel.

23. A device according to claim 22, wherein
a section of the outlet channel branches off in the cover above the stepped face.

24. A device according to any one of claims 21 to 23, wherein
a valve body spigot which fits into the outlet channel with a small clearance for movement projects downwardly from the valve body.
